(19) United States
(12) Patent Application Publication
(10) Pub. No.: US 2011/0000666 A1
(43) Pub. Date: Jan. 6, 2011

(54) Vitiated Steam Generator

(76) Inventor: Heraldo Da Silva Couto, Sao Paulo (BR)

Correspondence Address: Hollingsworth & Funk, LLC., Suite 320, 8500 Normandale Lake Blvd., Minneapolis, MN, 55437, US

(21) Appl. No.: 12/883,654

(22) Filed: Sep. 16, 2010

Related U.S. Application Data
(63) Continuation-in-part of application No. PCT/BR2008/000084, filed on Mar. 19, 2008.

(51) Int. Cl. F22B 1/18; F02C 7/00; E21B 43/24

(52) U.S. Cl. 166/272.3; 60/39.55; 60/39.59; 60/805

(57) ABSTRACT

The device of the present invention belongs to the field of the steam generators devices. Specifically, the device described herein is based constructively in a rocket-type engine for generates instantaneously a vitiated steam, which is a mix of water steam with combustion gases. The device described herein is a modular device whose each module may be changed in case of break or clogging. The device of this invention provides energy for the operation of different steam equipment, such as turbines, engines, locomotives, among other possible, as well as the combination of them. The device of this invention may also be attached in petroleum wells, making feasible the extraction of petroleum from the mature wells.

### CROSS-REFERENCES TO RELATED APPLICATIONS

This application is a continuation-in-part of International Application PCT/BR2008/000084, with an international filing date of 19 Mar. 2008 (19.03.2008), which designated the U.S. and which is incorporated herein by reference in its entirety.

### FIELD OF THE INVENTION

The device of this invention belongs to the field of the steam generators devices. Specifically, the device herein described is based constructively in a rocket-type engine and generates instantaneously a vitiated steam, which is a mix of water steam with combustion gases. The device described herein is a modular device whose the modules may be changed in case of break or clogging. The device of this invention provides energy for the operation of different steam equipments, such as turbines, engines, locomotives, among other possible, as well as the combination of them. The device of this invention may also be installed in petroleum wells, making feasible the extraction of petroleum from the mature wells.

### BACKGROUND

The generation of steam is traditionally made by boilers that are composed of a solid, liquid or gaseous combustible burner, of a heat exchanger that has the function to transmit the generated heat by the burnt of the combustible to the water, without having the direct contact to the water, and comprises a reservoir, in which the steam resulted from the water evaporation is accumulated. The heat of the combustible burnt is transmitted to the water that is heated up to its evaporation temperature. The steam produced is accumulated in a reservoir until it reaches the desired pressure for its usage; therefore, there is a delay among the onset of the water heat, its transformation into steam, and its use.

Basically, the heat exchanger may be aqua-tubular, in which the water passes through the tubes, whose external surface is exposed to the heat generated by the combustible burn, or flame-tubular, in which the heat generated in the combustion passes through tubes emerged in water, or yet in a mixed embodiment. However, it is observed that the vaporization process of the water in boilers is a slow process, once a great quantity of heat must be provided in order to reaches the evaporation stage. Thus, a great part of the heat provided by the combustible burn is lost during this initial water heating step until the vaporization is obtained and, yet, part of this heat is still being lost by the chimney.

It is observed that the steam generated in the boilers presents a low pressure and a low temperature, making unfeasible its immediate usage in systems that require steam at a high pressure and temperature. In order to reach the increased pressure and temperatures, the generated steam is stored in tanks with great dimensions and heated through the usage of super-heaters. It makes unfeasible the usage of boilers in small areas and makes the process with an increased cost once such super-heaters are expensive equipment.

Another problem observed in the usage of boilers is related to the exhaust of gases arising from the combustion directly to the atmosphere. It is observed that the regions close to the areas where the boilers are installed, in general, present a high index of pollutant such as, for example, NOx, thus causing an environmental problem.

The pressure of the generated steam is a little below the pressure provided by the pump that pumps water to the boiler, and the temperature of the generated steam is the temperature of evaporation/saturation in the same pressure.

By leaving the boiler, the steam may be super-heated, keeping the pressure in which it was generated through the usage of a device named super-heater. The boiler is used in industrial, thermoelectric, heating processes, etc.

Although widely used, the boiler presents some problems regarding its great volume, weight, cost and delay to start the production of steam at the desired temperature and pressure. The cost is considerably increased at the production of steam at high pressures and temperatures, because they require special materials for its building.

In spite of these disadvantages, the boiler is widely used because there are no equivalent devices that substitute it with an advantage. Thus, it is desirable the development of low-cost technologies that are more efficiently than the boilers, and make viable the generation of steam at the desired pressure and temperature.

The prior art reveals some documents that describe steam generators devices.

The document U.S. Pat. No. 4,224,991 discloses a vitiated steam generator device intended to be used in petroleum wells whose combustion process includes the oxi-combustion. This equipment includes a combustion chamber, which has a reaction chamber and an evaporation chamber, which are axially disposed with a constriction nozzle separating them. The reaction chamber is separated from the chamber of turbulence by a constriction. In this equipment, the water is simultaneously directed to the region of constriction between the evaporation chamber and the reaction chamber and to the device where there is the combustible burn, taking part in the combustion. At this equipment, the cooling of the combustion chamber is performed through a liquid oxygen, which, after the heating, is converted in chemical oxygen, being directed to the device where there is the burn of the combustible.

The document U.S. Pat. No. 4,366,860 discloses a vitiated steam generator device intended to be used in petroleum wells, that includes a combustion chamber with an external circuit of water and water injectors at the exit. Such injectors promote the direct contact between the water and the combustion gases; but not all the water is immediately vaporized once part of it remains adhered to the wall under the form of a film. The combustion chamber presents a divergent format that results in the loss of velocity of the gases generated in the combustion. In this device, the water passes externally to the combustion chamber and it is conducted to the injectors at the exit of the combustion chamber. At this device, part of the water that passes through these injectors presents a laminar drainage at the device wall, making unfeasible the usage of the device at the horizontal position. In addition, the device described in this document does not operate at a high pressure.

The document U.S. Pat. No. 4,861,263 discloses a method and an apparatus to be used in petroleum wells that comprises the usage of a modular vitiated steam generator device whose modules may be cleaned or changed in case of break or malfunction. The combustion chamber of the device described in this document comprises an internal ceramic coating and restriction areas in order to improve the efficacy of the combustible burn. The device described in this document is constituted by a ring configuration around the combustion chamber by which the water to be vaporized is passed. This ring does not present a water exit, in such a way that the whole water that comes into the device must be vaporized. The water entrance at the vaporization chamber described in this document takes place not for injectors, but for apertures/entrances at the combustion chamber wall. It probably implies at the appearance of increased-size drops, making difficult the fast vaporization. This device may present a maximum external diameter of 13 inches and does not present any mechanism of increase the velocity of the combustion gases.

The document U.S. Pat. No. 4,380,267 discloses a vitiated steam generator device to be used in petroleum wells that comprises, in a same axis, a compressor and a turbine, between both of them is disposed a combustion chamber and, after the turbine, a steam generation area. At this device, the compressor compress the air at a high pressure, which is later heated and conducted to the combustion chamber, where it suffers an ignition together with the fuel. The gases generated at the fuel burn pass through the turbine generating the energy necessary for the operation of the compressor. After the passage through the turbine, the combustion gases get into the steam generation area, getting into contact to the water arising from an external circuit to the combustion chamber. The entrance of water at the steam generation area takes place through cracks at the wall of this chamber, and not through injectors. Such cracks generate the appearance of a laminar drainage, which do not allowed the instantaneous and full vaporization of the whole water mass, once part of this mass remains adhered to the wall under the form of a film.

The document U.S. Pat. No. 4,411,618 discloses a vitiated steam generator device intended to be used in petroleum wells that operates vertically, and includes an external pre-heating step of the fuel. At this device, the pre-heated fuel is mixed to the air and later conducted to a combustion area where it is ignited. The water flows in an external circuit to this combustion area and after the pre-heating by heat exchange, it is conducted to spray injectors at the combustion chamber exit. Such injectors are small apertures disposed on a ring way and generate the appearance of a laminar drainage at the steam generation area. Thus, there is no instantaneous and total formation of vitiated steam, once part of the water remains adhered to the inner wall of the device. It is also observed that there is no device to increase the velocity of the gases generated at the combustion.

The document U.S. Pat. No. 4,385,661 discloses a vitiated steam generator device that uses a pre-heated fuel. At this document, the external wall of the combustion chamber is filled by water in two concentric circuits; at the end of them, the water is directed to the interior of the combustion chamber through the apertures. Such apertures do not constitute injectors and once in the combustion chamber, most part of the water flows in a laminar flow through the wall, making unfeasible the usage of the equipment in another position, other than the vertical one. Such laminar drainage does not generate the instantaneous formation of steam, once a water film remains adhered to the wall. The pre-heating of water and the fuel take place through a deviation of the vitiated steam part formed for an external circuit to the water circuit. Thus, not the whole generated vitiated steam can be used for the purpose it is intended for, once there is always a deviation of part of it for the pre-heating of water and fuel.

### BRIEF DESCRIPTION OF THE INVENTION

In view of the foregoing, the inventors of this invention developed a steam generator device that reduces many problems presented by the boilers of the prior art. The generators herein described are vitiated steam generators, that means a mix of water steam with combustion gases, whose construction is based on the principle of the rocket engine.

Rocket engines are engines that include a combustion chamber and a convergent/divergent nozzle, also known as Laval nozzle. In these engines, the energy generated by the fuel burn generates the rocket propulsion by the increase of velocity of the gases generated at the fuel burn by passing through the nozzle. The passage of the combustion gases through the nozzle results in the obtainment of velocities in the order of MACH 1.

Devices such as those herein described comprise a vaporization chamber attached to the combustion chamber of a rocket engine, said combustion chamber is externally involved by a cooling system, and the nozzle includes spray water injectors.

The advantage of the presence of a cooling system around the combustion chamber is that it does not only promote the cooling of it, as well as simultaneously pre-heats the cooling fluid.

In an embodiment, the cooling fluid is the water that is vaporized.

In an embodiment, the cooling fluid is an oxidizing gas, such as, for example, the air, which after being pre-heated, takes part in the combustion process.

The cooling system comprises an embodiment in jacket disposed between the combustion chamber wall and the housing.

In an embodiment, the cooling system includes an embodiment in jacket around the combustion chamber and the nozzle forming a unique module.

In an embodiment, the cooling system includes an embodiment in jacket around the combustion chamber and the nozzle, which is disposed in different modules.

In an embodiment, the cooling system includes water and an oxidizing gas that circulate in different modules.

In addition, another constructive advantage is the disposition of the nozzle at the combustion chamber exit, providing the generation of vitiated steam in velocities close to MACH 1. This feature makes feasible the usage of the equipment vertically, horizontally, or also inclined.

At the generators herein described, the vaporization chamber (10, C) presents a convergent nozzle that increases even more the velocity of the generated vitiated steam.

The spray water injectors of the nozzle comprise at least two channels, from which, one of them communicates to the cooling system and the other one communicates to the combustion chamber, making feasible the contact of part of the water of the cooling system with part of the gases generated in the combustion chamber.

The generators herein described may be operated with liquid or gaseous fuels, as well as with hypergolic pairs or yet with liquid gunpowder.

The generators of this invention present numerous advantages, including the advantage of forming a vitiated steam without a direct contact between the water and the flame, providing the advantage of hindering the flame extinguishment, or the freezing of the combustion chemical reactions.

The vitiated steam generators devices herein described may be attached through the vaporization chamber exit in different equipments that operate by steam, such as: turbines, engines, locomotives among other possible equipments, as well as the combination of them.

The vitiated steam generators devices such those herein described may be used at the generation of energy, once they instantaneously generate a mix of combustion gases with water steam, forming a vitiated steam, under high pressure and high temperature. In the case that the invention is used for such purpose, the generators operate through the connection to electromechanical equipment such as, for instance, turbines.

The vitiated steam generators devices, such those herein described, may yet be used at the petroleum extraction, in which it is introduced directly within the well and making feasible the extraction of petroleum from the mature wells.

The generator, object of this invention, is a low-cost device with compact dimensions, presenting dimensions that may reach around 1/10^{th} of the dimensions of an equivalent boiler. However, as must be appreciated by a person skilled in the art, such generator may presents varied dimensions in accordance to the specifications of the project to which it is intended for.

The vitiated steam generators devices, such as those described herein, comprise modular devices that may be exchanged in case of break or clogging, or also cleaned in case of soot deposit at the device walls.

In an embodiment, the generator device herein described comprises three modules, wherein the first module includes a combustion chamber having a head, a nozzle with spray water injectors and a cooling system, a second module, attached to said first module, includes a vaporization chamber, and a third module attached to the second module, including a convergent nozzle.

In an embodiment, one of the generator modules comprises a combustion chamber having a head and a cooling system, with said module being attached in a second module, having a nozzle with spray water injectors and a cooling system, and attached to this second module there is a third module including a vaporization chamber having a convergent nozzle.

Another advantage about the usage of vitiated steam generators, such as those herein described, in relation to the boilers is that it does not require the pre-heating step. This is possible because it is able to produce instantaneously steam at the desired quantity, pressure and temperature, dismissing the usage of super-heaters. Also, another advantage is that it dismisses the need of use reservoirs with big-dimensions to accumulate the steam.

Vitiated steam generators devices, such as those herein described, perform the same functions of the boiler, but with more increased yielding, once great part of the heat generated in the combustion is used at the vaporization of water, while in the boiler great part is lost during the heating of the water until it reaches the vaporization temperature. The usage of such generators has also the advantage of eliminate the necessity of use a vitiated steam storage tank until it reaches the desired pressure. In addition, it has the advantage of does not exhaust hot gases resulted from the burn of fuel directly to the atmosphere. The instantaneous generation of vitiated steam without the usage of ducts or alike, such as in the boilers, reduce the loss by radiation, once the infra-red radiation is all absorbed by CO₂ and by the water steam generated at the combustion.

The generators devices herein described present the advantage of reduce the formation and exhaust of NOx, once it allows for the direct insertion of water steam in the combustion products.

The generator device of this invention is much more economic than a boiler with an equivalent capacity. This is why it is able to decrease in about 50% the fuel expenses. In addition, the generators herein described may also present different formats in accordance to its application, such as, for instance, the cylinder, conical, conical-square, conical-elliptical formats, among other possible ones, including a combination of them.

Thus, it must be clear that the person skilled in the art will know how to value the information herein described at the light of the illustrated drawings and the detailed description of the object of this invention, showed as follows.

### BRIEF DESCRIPTION OF THE DRAWINGS

The purposes and technical effects provided by the vitiated steam generator device, object of this invention, will be apparent to the person skilled in the art, from the detailed and exemplifier description as follows, making reference to the attached schematic figures, in which:

FIG. 1 shows a cut view of the vitiated steam generator device, according to this invention;

FIG. 2 shows a schematic view of a possible embodiment of the vitiated steam generator system, according to this invention;

FIG. 3 shows a partial cut view of the upper area of the combustion chamber, such as the one showed on the device of FIG. 2; and

FIG. 4 shows a cut view of the nozzle area of the device showed in FIG. 2.

### DETAILED DESCRIPTION OF THE DRAWINGS

In accordance to the figures indicated above, the vitiated steam generator device, object of this invention, includes basically a rocket engine constituted by a combustion chamber (7, A) having a cooling system (2), a nozzle that has spray water injectors, in such a way that said combustion chamber is connected to a vaporization chamber (10, C) whose end includes a nozzle by which the vitiated steam leaves (11).

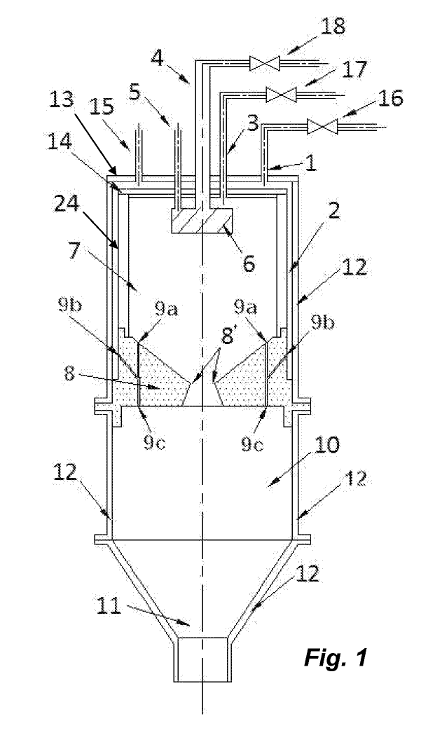

At the embodiment indicated in FIG. 1, the vitiated steam generator device includes 3 modules, wherein the first module includes a combustion chamber (7) with a head, a nozzle (8) and a cooling system (2); a second module with a vaporization chamber (10,C) and a third module with a nozzle (11) by which the generated vitiated steam leaves.

The module that includes the combustion chamber is composed of a water entrance duct (1) that feeds a water jacket (2) of the cooling system around the combustion chamber and the nozzle (8) provided with spray water injectors (9a, 9b and 9c). Also, this device comprises a head provided with feeding systems constituted by ducts for feeding air (3) and fuel (4), said ducts are directed for the feeding of the combustion chamber (7), in which it is disposed an ignition system (5) and a flame holder (6).

In said combustion chamber (7) of the vitiated steam generator device a vaporization chamber is attached (10, C), in which the end is disposed the steam exit (11).

The device herein described is involved by a housing (12) and said combustion chamber includes a device closing lid (14), as well as a water jacket lid (13).

In accordance to FIG. 1 indicated, the water (1), air (3) and fuel (4) entrance ducts have, respectively, sensors and/or flowing controllers (16, 17, 18) whose purpose is to assure precisely the correct quantity of material flow, which is provided to the vitiated steam generator. In this sense, it is allowed to obtain an efficient control about the relation between the fuel burn and the quantity of water in order to generate the steam in certain pressure and temperature conditions.

Said nozzle (8) forms a throat region (8′), which includes a spray water injector device, constituted by communication channels (9a, 9b e 9c), wherein the channel (9a) being the communication channel to the combustion chamber (7), the channel (9b) being the communication channel to the cooling system, and the channel (9c) being the convergence point of said channels (9a and 9b).

Said water jacket (2), that constitutes the cooling system, comprises a water exit (15) whose purpose is the maintenance of the temperature and the circulation of water flow around the combustion chamber. In addition, in order to control the cooling of the inner wall of the combustion chamber, said water jacket has a temperature sensor (24) and a water exit flow sensor and controller (not showed in the figure).

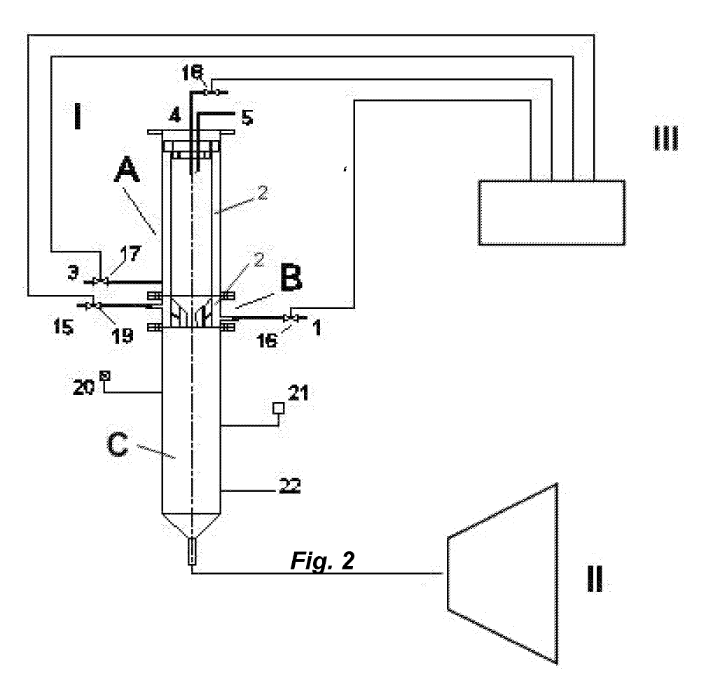

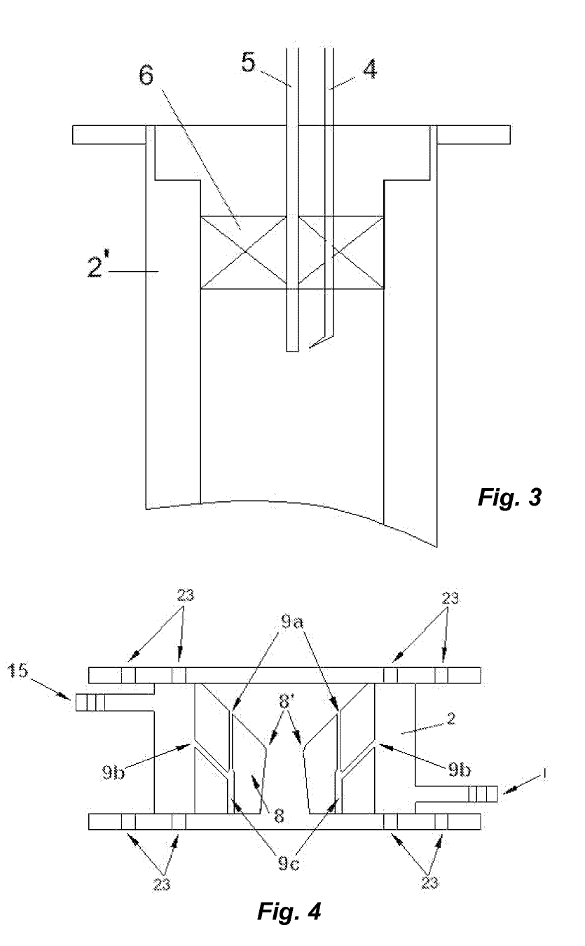

FIG. 2 shows a simplified scheme of a possible embodiment of the generators according to this invention, which comprise 3 modules from which the first module (A) comprises a combustion chamber with a head (FIG. 3) and a cooling system (2′), attached to this first module, there is a second module (B) comprising a nozzle having a cooling system and spray water injectors; and attached to this second module, there is a third module (C) comprising a vaporization chamber with a nozzle for the steam exit. The cooling system of this possible embodiment comprises a oxidizing gas at the jacket around the combustion chamber (2′), specifically air, and water at the nozzle jacket (2).

At this embodiment, as an example, the vitiated steam generator device (I) feeds a turbine (II) and it is monitored by a control and monitoring system (III).

In accordance to that is illustrated in FIGS. 2 and 3, in said combustion chamber (A) the ignition system (5) and the fuel duct entrance (4) having a flow sensor/controller (18) and the oxidizing gas/air entrance (3) are disposed with the respective flow sensor/controller (17). The water entrance (1) with the flow sensor/controller (16) and the water exit with the flow sensor (19) are connected at the combustion chamber area (B) that has a nozzle (8) in order to feed the spray water injectors. With the purpose to increase the equipment safety, sensors and valves are installed on the vaporization chamber, particularly, a pressure sensor (20), a temperature sensor (21) and a safety valve (22).

Also, in relation to FIG. 3, it is observed a detail of the combustion chamber head (7), in accordance to the embodiment showed in FIG. 2, in which the combustion chamber lid has a fuel entrance (4), the ignition system (5), a swirl (6), and a jacket (2′) through which the air circulates that, after cooling the combustion chamber passes by the swirl (6) and it is conducted to the interior of it through a passage in the jacket (not shown in the figure).

FIG. 4 shows a detail of the nozzle (8) of the vitiated steam generator device showed in FIGS. 1 and 2. It is verified that the nozzle (8) defines a throat region (8′), wherein said area is provided with spray water injectors that comprise the communication channels (9a) with the combustion chamber, the communication channels (9b) with the cooling system and the channels (9c) that form a convergence point of said channels (9a) and (9b).

In the embodiment showed in FIG. 1, it is observed that the water feeding in the device takes place by the entrance (1), and to assure that the flow and the water feeding control, there is a water exit (15).

In the embodiment showed in FIG. 2, it is observed that the feeding of water for the nozzle injectors takes place for the water entrance at the nozzle itself (1) and to assure the constant flow, there is also in the nozzle a water exit (15).

In FIG. 4 some areas are indicated (23) regarding the fixation elements of the combustion chamber at the vaporization chamber.

### DETAILED DESCRIPTION OF EXAMPLES

The examples showed as follows have the purpose to exemplify; however, without limiting the different possibilities of concretization of this invention being independent and not inter-related examples.

For purposes of this invention, it is considered as hypergolic pairs any pair of chemical compounds that come into ignition on such a spontaneous way and not in the presence of oxygen.

The vitiated steam generator device, object of this invention is a device that has as a constructive basis an engine of the rocket type, generating a great quantity of vitiated steam at a high pressure and high temperature through the water vaporization of the cooling system, without the direct contact between the water and the flame, but having a contact to the hot gases arising from the combustion.

The devices, according to this invention, may present different sizes, varying in accordance to the equipment to which it may be attached. They may also be used vertically, horizontally or inclined, and present different formats in accordance to the usage to which they are intended for, such as, for instance, the cylinder, conical, conical-square, conical-elliptical formats, among other possible, including the combination of them.

The device of this invention may be attached in different equipment that its operate depends on the steam, such as: turbines, engines, locomotives, among other possible ones, including the combination of them.

An application, of a particular interest for the generators herein described, is for the generation of electrical energy when they are attached, for instance, in turbines.

With a great efficacy, the generator devices herein described may be used in petroleum wells.

With the purpose to make clear and precise this description, some specific descriptions will be done as follows about the components that constitute the device of this invention.

### Materials

The materials that may be employed at the construction of the vitiated steam generator herein described are rigid materials that resist to high temperatures and pressure, presenting a minimal deformation capacity. As examples of such materials, we may mention the stainless steels as stainless steel 304, stainless steel 304L, among other possible types of materials, as well as the combination of them.

### Combustion Chamber

The combustion chamber (7) of the vitiated steam generators devices, herein described, comprises a head, a cooling system (2) and spray water injectors (9a, 9b and 9c) at the nozzle (8).

### Head

The head comprises a fuel feeding system (4), an air injection system (3), an ignition system (5) and their respective control systems (16, 17, 18, 24).

The head of this vitiated steam generator device is a head compatible to the usage of liquid or gaseous fuel.

### Fuel Feeding System

The fuel feeding system of this invention may be any liquid or gas injection systems known in the prior art, that include spray injectors, jet injectors, swirls, among other possible ones, as well as the combination of them. Other types of devices, such as, for instance, flame retainers as screens, bluff-bodies and swirlers may also be used.

In an embodiment, the fuel feeding system of the generators herein described is a spray injector and has a swirl (6), as illustrated in FIG. 3.

In an embodiment, the fuel feeding system of the generators herein described is a spray injector and has a flame holder device (6), as illustrated in FIG. 1.

### Fuel

The fuel used at the vitiated steam generator device of this invention is a fuel chose from the group that includes the gaseous fuels, such as GNV, GLP, methane, among other possible ones, as well as the group of the liquid fuels, that includes gasoline, kerosene, alcohol, among other possible ones, including a mixture of those fuels.

The fuel used in the generators herein described is chose from the group that includes the fuels which combustion depends on the air or not. It is possible, for instance, use in the generators herein described the liquid gunpowder, or yet hypergolic pairs such as, for instance, the nitric acid/alcohol type pairs, such as the nitric acid/methanol, nitric acid/ethanol, nitric acid/propane, nitric acid/butane, among other possible ones, as well as other types of combustible compounds whose the combustion does not depend on the air, including a mixture of such materials.

In an embodiment, the fuel used is a combustible gas.

### Air Feeding System

The air feeding system of the generator herein described injects air into the combustion chamber under high pressure, making feasible the combustion of fuels whose combustion depends on the air.

In another embodiment, the air feeding system comprises the injection of a single gas.

In an embodiment, the air feeding system comprises the injection of a gaseous mixture that is a different composition of the air composition.

In an embodiment, the air feeding system of the generators of this invention is inoperable or absent, being used as a fuel, a fuel whose combustion does not depend on the air, such as the liquid gunpowder or yet a hypergolic pair, such as, for example, those previously mentioned.

### Ignition System

The ignition system used in the generators herein described is a system compatible to the fuel used and already known in the prior art.

In an embodiment, the ignition system of this invention comprises an ignition candle (5) and a feeding electrical source.

In an embodiment, the ignition system is absent or inoperable and the device of this invention operates with a hypergolic pair such as, for instance, the pairs previously mentioned in the item regarding the fuels.

In an embodiment, the ignition system is absent or inoperable and the generator herein described operates with liquid gunpowder.

### Cooling System

The cooling system of the combustion chamber of the generators herein described comprises a cooling fluid that circulates in an embodiment in jacket between the burn area of the combustion chamber and the housing, encompassing the combustion chamber (2) and (2′) and the nozzle, as are illustrated in FIGS. 1 and 2. This embodiment allows making the thermal isolation of the combustion chamber.

In an embodiment, the cooling system comprises two embodiments in jacket different from each other, in which a jacket (2′) encompasses the combustion chamber, as illustrated in FIG. 2 and the other jacket (2) encompasses the nozzle area (2), such as identified in FIG. 2.

In an embodiment, the cooling fluid of the cooling system is the water.

In an embodiment, the cooling system comprises two different cooling fluids where one of them is the water and the other one is an oxidizing gas. At this case, the water circulates the jacket of the nozzle area (2) and the oxidizing gas circulates the jacket of the combustion chamber (2′), such as it is identified in FIG. 2. In this embodiment, the oxidizing gas is heated by the heat arising from the combustion chamber and it is directed to the interior of it, through the passage by a swirler, on such a way to take part effectively of the fuel combustion process.

In an embodiment, the oxidizing gas is the air.

In an embodiment, the oxidizing gas is different from the air.

### Divergent Nozzle With Spray Water Injectors

The divergent nozzle includes the Laval nozzle and has spray water injectors disposed all over the area. The advantage of the usage of spray injectors is that they present a higher efficacy at the steam formation.

Such injectors include, at least, two channels, in which one of the channels (9a) is in direct contact to the combustion chamber and the other one (9b) is in direct contact to the cooling system, making thus feasible the contact of part of the gases generated at the combustion to part of the water of the cooling system, generating the vitiated steam.

The spray water injectors are chosen from the group that comprises spray injectors known in the prior art, such as spider Jet-, “Y” Jet-, splash-plate-type injectors, among other possible ones, as well as the combination of them.

In an embodiment, the injectors used in the generators described herein, present a “Y” Jet-type model. Such injectors present a better efficacy in the formation of the spray, once they cause the nebulization of the water before it get into contact to the combustion gases. The nebulization of the water generates some drops with a mean diameter (sauter mean diameter SMD) in the order of 30 μm, making feasible the instantaneous formation of the steam when it is in contact to the combustion gases. In addition, the usage of such injectors makes feasible the construction of a vaporization chamber with a smaller length in relation to the usage of other types of injectors.

In an embodiment, the injectors herein described comprise only channels (9a) and (9b).

In an embodiment, the injectors herein described comprise many channels (9a) and many channels (9b) that convert to the same area of convergence (9c) constituting the “Spider Jet”-type injector.

In an embodiment, the injectors herein described comprise many channels (9a) and many channels (9b) converting to different areas of convergence (9c).

### Components Intended to the Measurement and Control of the Combustion Chamber

The components intended to the measurement and control of the combustion system are components that aid in the control of the system, such as pressure, temperature and chemical sensors, flow and pressure controllers, as well as components that act in the safety of the system, such as relief valve among other possible components, as well as the combination of them.

The purpose of these components is to monitor and control safely the device and, mainly, promote the generation of vitiated steam at the condition and properties desired for the projected purpose.

Specifically, and as indicated in the figures, the combustion chamber herein described comprises a sensor/controller of the water flow (16), a sensor/controller of the air flow (17), a sensor/controller of the fuel flow (18), a temperature sensor at the jacket of the cooling system (24). Such sensors and controllers may be manually operated or through a central system of automated control (III) as indicated schematically in FIG. 2, as an example.

### Vaporization Chamber

The vaporization chamber herein described comprises a location where there is a mixture of pulverized water by the spray water injectors of the nozzle with the greatest part of the gases generated at the combustion, forming the vitiated steam. The vaporization chamber is attached to the combustion chamber as showed in FIG. 1.

The vaporization chamber also comprises the compounds chosen from the group that consists of sensors/controllers of pressure, temperature, flow, chemical sensors, among other possible ones, as well as the combination of them, and also a control and monitoring system of all equipment, centralizing the information of all sensors.

In an embodiment, the vaporization chamber comprises temperature (20), pressure (21) sensors, and pressure relief valves (22) and a control system of them, which may be bound or not to the control and monitoring system (III) that centralizes all other sensors.

In an embodiment, the vaporization chamber is attached in a turbine.

### Example 1

### Vitiated Steam Generator Comprising Water in the Cooling System

The vitiated steam generator device herein described may presents different formats of the combustion chamber and the nozzle exit, which may be: conical, cylindrical, conical-square, conical-elliptical, etc.

The generation of vitiated steam, in the desired pressure and temperature, is performed directly, i.e., instantaneously. The generation of vitiated steam is applicable where there is a need of steam, in order to keep or increase the local temperature, and also to keep or increase the pressure in the location, and may be used in different applications not foreseen at this descriptive report, such applications in which a small contamination of combustion gases steam is tolerable, such as replace boilers in the functions of move turbines for the generation of electrical energy, provide a steam for the extraction of gases and decrease of the pressure, or even produce a process steam, in addition to many other applications that are known by the person skilled in the art. An innovative application area is the injection of steam into petroleum wells for the recovery of mature wells “in situ”, i.e., with the installation of vitiated steam generator directly within the well. The format of the combustion chamber and the exit of the nozzle are adequate according to the necessity of the project, which may be: conical, cylindrical, conical-square, conical-elliptical, etc.

At the electricity generation area, gas turbines have a great yield because they operate with combustion gases at high temperatures, but they spend a great part of the energy produced at the pumping of the air to the combustion chamber, on such a way that the global yield of the system is comparable to the steam turbines that operate normally at smaller temperatures. The employ of the vitiated steam generator in steam turbines used at the generation of electricity has the merit to increase the temperature of the steam up to a desired value, for example, 600° C. or more, on such a way to increase the yield of the thermal cycle. The pumping of air for the combustion chamber of the vitiated steam generator is significantly inferior to the pumping required by combustion chambers used in gas turbines.

FIG. 1 shows the vitiated steam generator herein described that presents a cylindrical format, in which the cooling system comprises just water that circulates both in the upper part of the combustion chamber and the nozzle area.

The combustion chamber is attached to the nozzle (the assembly is based on a rocket engine) and the water jacket involves the combustion chamber and the nozzle. From the inner part of the water jacket, at the divergent area of the nozzle, it the nebulized water is injected through different injectors (sprays) disposed in nozzle and in an angle on such a way that the nebulized jets arising from those injectors to take place at certain distance in direction to the sides of the flame arising from the combustion chamber; however not touching said flame. Thus, the hot gases generated in the combustion chamber when in contact to the nebulized water produces steam in the vaporization chamber which is expelled by the steam exit.

The device is very compact, corresponding to less than a 1/10 of the boiler with an equivalent capacity. In addition, it has a high yield, once the generation of vitiated steam is performed directly, i.e., instantaneously, not using tubes and/or similar. It decreases the loss of heat by radiation, once the infra-red radiation is all absorbed by CO₂ and water steam generated in the combustion.

The device herein described also reduces the exhaust of NOₓ once it allows the direct insertion of the water steam at the combustion production.

The heat generated at the combustion is totally used, because the combustion gases are mixed to the steam generated, diverging, therefore, from the boilers where the combustion gases are released to the environment yet in a hot condition.

Its high yield is also due since it does not require the usage of super-heaters.

The size of the nebulized water drops by the sprays is calculated on such a way to vaporize by getting in contact to the gases arising from the combustion. The mean temperature of the steam jet and the combustion products is calculated in accordance to the fuel flow employed and the used water flow. With this device, it is possible to generate steam at the intended quantity and at the temperature and pressure needed.

In case of usage of liquid fuel, the size of the fuel drops is calculated on such a way that they are vaporized at the inner side of the combustion chamber and totally burnt within it.

FIG. 1 shows this vitiated steam generator device comprising water in the cooling system where (1) is the water entrance with the flow sensor/controller (16), (2) is the water jacket, (3) is the air entrance with the flow sensor/controller (17), (4) is the fuel entrance with the flow sensor/controller (18), (5) is the ignition system, (6) is flame retainer, (7) is the combustion chamber, (8′) is the throat area defined by the nozzle (8), (9a), (9b) and (9c) comprises the spray water injector system where (9a) is a communication channel with the combustion chamber, (9b) is the communication channel with the cooling system and (9c) is the convergence point of the channels (9a) and (9b); (10) is the vaporization chamber, (11) is the steam exit, (12) is the housing, (15) is the water exit of the cooling system, (13) is the water jacket lid, (14) is the combustion chamber lid and (24) is the temperature sensor present in the cooling system jacket.

### Example 2

### Vitiated Steam Generator Comprising Water and an Oxidizing Gas in the Cooling System

The vitiated steam generator device comprising water and an oxidizing gas, in this case, the air presents the advantage of allowing the heating of the air by the heat arising from the combustion chamber and re-conduct it to the combustion chamber entrance, making it take part effectively on the combustion process.

FIG. 2 shows a simplified scheme of this equipment with a cylindrical format where (I) is the vitiated steam generator device, in which the cooling system comprises an oxidizing gas at the jacket around the combustion chamber and water at the jacket of the nozzle area, (II) is the turbine and (III) is the control and monitoring system of the vitiated steam generator. In this Figure, (A) is the combustion chamber, (B) is the nozzle with cooling system (2) and spray water injectors (9a, 9b, 9c), (C) is the vaporization chamber, (5) is the ignition system, (4) is the fuel entrance with the flow sensor/controller (18), (3) is the oxidizing gas entrance/air with the flow sensor/controller (17), (1) is the water entrance with flow sensor/controller (16), (15) is the water exit with the flow sensor (19), (20) is the pressure sensor, (21) is the temperature sensor and (22) is a safety valve.

FIG. 3 shows a detail of the upper part of the combustion chamber of the vitiated steam generator device showed in FIG. 2 where (4) is the fuel entrance, (5) is the ignition system, (6) is the flame holder (swirl), and (2′) is the jacket by which the air circulates.

FIG. 4 shows a detail of the nozzle of this equipment where (8′) is the throat area defined by the nozzle (8), (9a) is a communication channel with the combustion chamber, (9b) is a communication channel with the cooling system and (9c) is the channels convergence point (9a) and (9b), (1) is the water entrance, (15) is the water exit and (23) are the fixation elements.

It is worthy to highlight that a person skilled in the art will know how to value the information herein described and make the variants not foreseen at this time, but yet within the same inventive concept.

1. VITIATED STEAM GENERATOR, wherein it comprises a compact, modular device, of the rocket type, comprising a combustion chamber having a head, a cooling system and spray water injectors disposed at a nozzle and attached to it, a vaporization chamber with a convergent exhausted nozzle.

2. GENERATOR, in accordance to claim 1, wherein it comprises three modules from which a first module comprises a combustion chamber having a head, cooling system and a nozzle with spray water injectors, attached to this first module, a second module comprising the vaporization chamber, and attached to this second module, the third module composed by convergent exhausted nozzle of generated vitiated steam exit.

3. GENERATOR, in accordance to claim 1, wherein it comprises three modules from which a first module comprises a combustion chamber having a head and a cooling system, attached to this first module, there is a second module that comprises the nozzle with spray water injectors, and a cooling system, and attached to this second module, a third module comprising a vaporization chamber with a convergent exhausted nozzle of the generated steam.

4. GENERATOR, in accordance to claim 1, wherein the cooling system is filled by a cooling fluid and comprises an embodiment in jacket between the combustion chamber and the housing, having an entrance and an exit.

5. GENERATOR, in accordance to claim 4, wherein the cooling fluid of the cooling system is the water.

6. GENERATOR, in accordance to claim 4, wherein the cooling fluid of the cooling system is the water and an oxidizing gas.

7. GENERATOR, in accordance to claim 6, wherein the oxidizing gas is the air.

8. GENERATOR, in accordance to claim 6, wherein the oxidizing gas is different from the air.

9. GENERATOR, in accordance to claim 1, wherein the spray water injectors are the “Y” Jet, Spider Jet, splash-plate, as well as the combination of them.

10. GENERATOR, in accordance to claim 9, wherein the spray water injectors are the “Y” Jet type.

11. GENERATOR, in accordance to claim 1, wherein the spray water injectors comprises channels that are in a direct contact to the combustion chamber and the channels that are in a direct contact to the cooling system, making feasible the contact of part of the water of the cooling system to part of the gases arising from the combustion.

12. GENERATOR, in accordance to claim 1, wherein the spray water injectors comprises channels that are in a direct contact to the combustion chamber, channels that are in a direct contact to the cooling system, making feasible the contact of part of the water of the cooling system to part of the gases arising from the combustion and channels of convergence of the channels.

13. GENERATOR, in accordance to claim 12, wherein the spray injectors comprise more than one channel converging to the same convergence channel.

14. GENERATOR, in accordance to claim 12, wherein the spray injectors comprise more than one channel converging to the same convergence channel.

15. GENERATOR, in accordance to claim 1, wherein it presents formats like cylindrical, conical, conical-square, conical-elliptical and the combination of them.

16. GENERATOR, in accordance to claim 15, wherein it presents a cylindrical format.

17. GENERATOR, in accordance to claim 1, wherein the generated vitiated steam acquires a high velocity close to MACH 1 through the nozzle in a convergent/divergent format.

18. GENERATOR, in accordance to claim 1, wherein the head comprises a fuel injection system, an air injection system and an ignition system.

19. GENERATOR, in accordance to claim 1, wherein it operates with a liquid, gaseous fuel, with hypergolic pairs or yet with fuels whose combustion does not depend on the air, such as the liquid gunpowder.

20. GENERATOR, in accordance to claim 19, wherein the fuel is GNV.

21. GENERATOR, in accordance to claim 18, wherein the air injection system comprises the air injection under pressure at the combustion chamber.

22. GENERATOR, in accordance to claim 18, wherein the feeding system of fuel comprises the usage of injectors chosen from the group that comprises the liquid and gases injectors devices, such as spray injectors, jet injectors, swirler, as well as the combination of them, and flame holder devices, such as screens, bluff-bodies and the combination of them.

23. GENERATOR, in accordance to claim 22, wherein the injector is a spray injector.

24. GENERATOR, in accordance to claim 22, wherein the feeding system of fuel comprises a swirl or a flame holder.

25. GENERATOR, in accordance to claim 18, wherein the ignition system comprises a candle and a feeding electrical source.

26. GENERATOR, in accordance to claim 1, wherein it comprises sensors/controllers of flow, pressure, temperature and a safety valve of operation control of it.

27. GENERATOR, in accordance to claim 26, wherein the sensors/controllers of flow, pressure, temperature, as well as the safety valve are manually operated.

28. GENERATORS, in accordance to claim 26, wherein the sensors/controllers of flow, pressure and temperature, and the safety valve are operated by an automated central device (III).

29. GENERATOR, in accordance to claim 1, wherein it is connected, through the exit of the vaporization chamber, in an equipment whose operation depends of the steam, such as turbines, engines, locomotives, as well as the combination of them.

30. GENERATOR, in accordance to claim 29, wherein it is connected to a turbine.

31. GENERATOR, in accordance to claim 1, wherein it is used for the generation of electrical energy.

32. GENERATOR, in accordance to claim 1, wherein it is connected to petroleum wells for the extraction in mature wells.

33. GENERATOR, in accordance to claim 1, wherein it operates vertically.

34. GENERATOR, in accordance to claim 1, wherein it operates horizontally.

35. GENERATOR, in accordance to claim 1, wherein it operates in the inclined direction.
